(19) United States
(12) Patent Application Publication
(10) Pub. No.: US 2007/0228979 A1
(43) Pub. Date: Oct. 4, 2007

(54) Plasma display panel

(76) Inventor: Jung-Tae Park, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/724,782

(22) Filed: Mar. 16, 2007

(30) Foreign Application Priority Data
Mar. 28, 2006 (KR) 10-2006-0028054

(51) Int. Cl. H01J 17/49

(52) U.S. Cl. 313/587; 313/582; 313/586

(57) ABSTRACT

Provided is a plasma display panel with improved ventilating capability. The plasma display panel includes a front substrate; a rear substrate that is located to face the front substrate, and defines a plurality of discharge cells which are arranged in a row direction and a column direction; and a barrier rib structure including first partitions formed between discharge cells arranged in the row direction, second partitions connecting the first partitions, and third partitions arranged between rows of the discharge cells, wherein the height of the first partitions is lower than the height of the third partitions.

### CROSS-REFERENCE TO RELATED PATENT APPLICATION

This application claims the priority of Korean Patent Application No. 10-2006-0028054, filed on Mar. 28, 2006 in the Korean Intellectual Property Office, the disclosure of which is incorporated herein in its entirety by reference.

### BACKGROUND OF THE INVENTION

1. Field of the Invention

The present embodiments relate to a plasma display panel, and more particularly, to a plasma display panel with improved ventilating capability.

2. Description of the Related Art

A plasma display apparatus is a flat display device that uses a plasma display panel (PDP) and a plasma discharge to display an image. Plasma display apparatuses are considered to be the next-generation display devices due to their good display characteristics, such as high brightness, high contrast, clear images, wide viewing angles, slim structure, and large screen size.

Recently, an increase in the resolution of the PDP has resulted in a reduction in the pixel size of the PDP. The high resolution of the PDP causes an increase in the volume of a barrier rib structure that defines pixels of the PDP, thus reducing the space between the upper and lower substrates of the PDP. Accordingly, it is difficult to exhaust impure gas remaining in the PDP.

### SUMMARY OF THE INVENTION

The present embodiments provide a plasma display panel that can achieve improved ventilating capability by controlling the height of a barrier rib structure thereof.

According to an aspect of the present embodiments, there is provided a plasma display panel comprising a front substrate; a rear substrate located to face the front substrate, the rear substrate defining a plurality of discharge cells which are arranged in a row direction and a column direction; and a barrier rib structure including first partitions formed between discharge cells arranged in the row direction, second partitions connecting the first partitions, and third partitions arranged between rows of the discharge cells, wherein the height of the first partitions is lower than the height of the third partitions.

Middle parts of the first partitions may be sunken.

The third partitions may be arranged to connect substantial middle parts of the adjacent second partitions. However, the third partitions may be arranged to substantially correspond to the first partitions. Also, the third partitions may be arranged to substantially correspond to middle parts of the second partitions, and the first partitions.

The plasma display panel may further comprise sustain electrodes extending along the discharge cells arranged in the row direction. At least a part of each of the sustain electrodes may be arranged to correspond to a region between rows of the discharge cells. Each of the sustain electrodes may operate in all of the discharge cells of adjacent rows. Each of the sustain electrodes may comprise a bus electrode arranged to correspond to a region between rows of the discharge cells, and a transparent electrode which is electrically connected to the bus electrode and extends in the row direction of the discharge cells.

The sustain electrodes may be arranged between the barrier rib structure and the front substrate.

The plasma display panel may further include address electrodes extending to intersect the sustain electrodes; a front dielectric layer and a rear dielectric layer formed to respectively bury the sustain electrodes and the address electrodes; phosphor layers arranged in the discharge cells; and a discharge gas filled in the discharge cells.

### BRIEF DESCRIPTION OF THE DRAWINGS

The above and other features and advantages of the present embodiments will become more apparent by describing in detail exemplary embodiments thereof with reference to the attached drawings in which:

FIG. 1 is a partially exploded, perspective view of a plasma display panel (PDP);

FIG. 2 is a cross-sectional view of the plasma display panel illustrated in FIG. 1, taken along the line II-II;

FIG. 3 is an arrangement plan illustrating the location of sustain electrodes, a barrier rib structure, and discharge cells illustrated in FIG. 1;

FIG. 4 is an arrangement plan illustrating the location of sustain electrodes, a barrier rib structure, and discharge cells in a modified example of the PDP of FIG. 1 in which third partitions are differently arranged than in the PDP of FIG. 1; and

FIG. 5 is an arrangement plan illustrating the location of sustain electrodes, a barrier rib structure, and discharge cells in another modified example of the PDP of FIG. 1 in which third partitions are differently arranged than in the PDP of FIG. 1.

### DETAILED DESCRIPTION OF THE INVENTION

Hereinafter, exemplary embodiments will be described in detail with reference to the accompanying drawings.

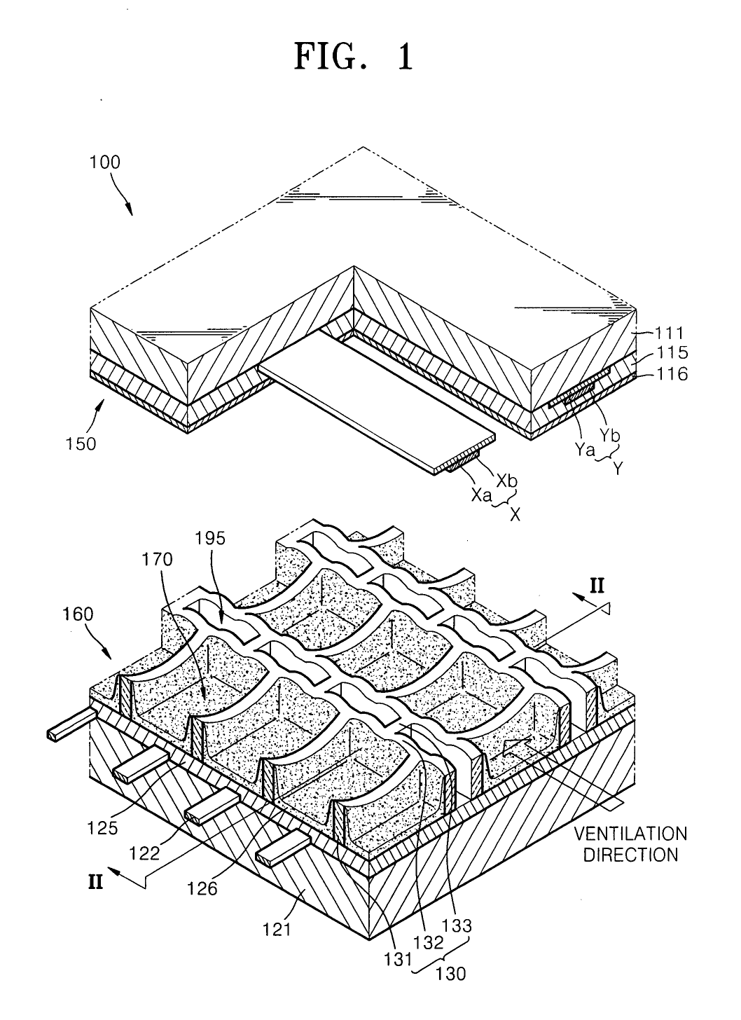

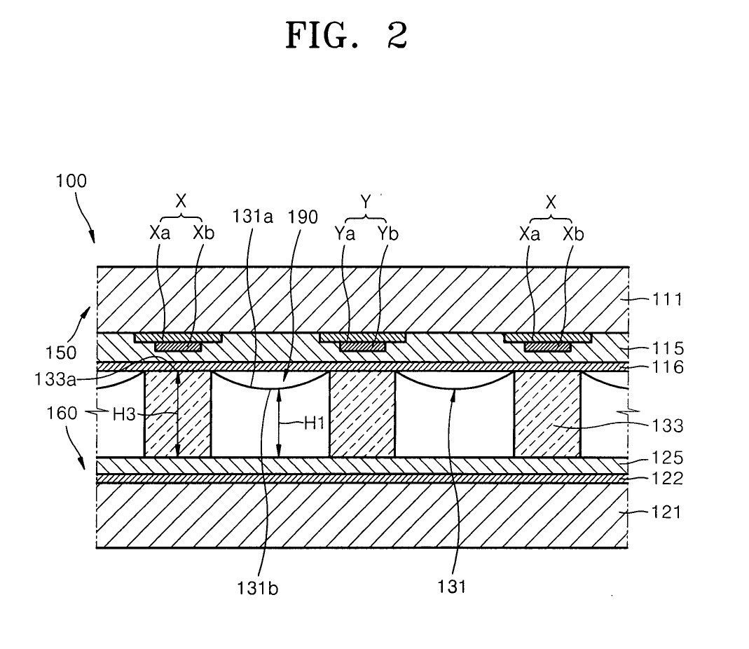

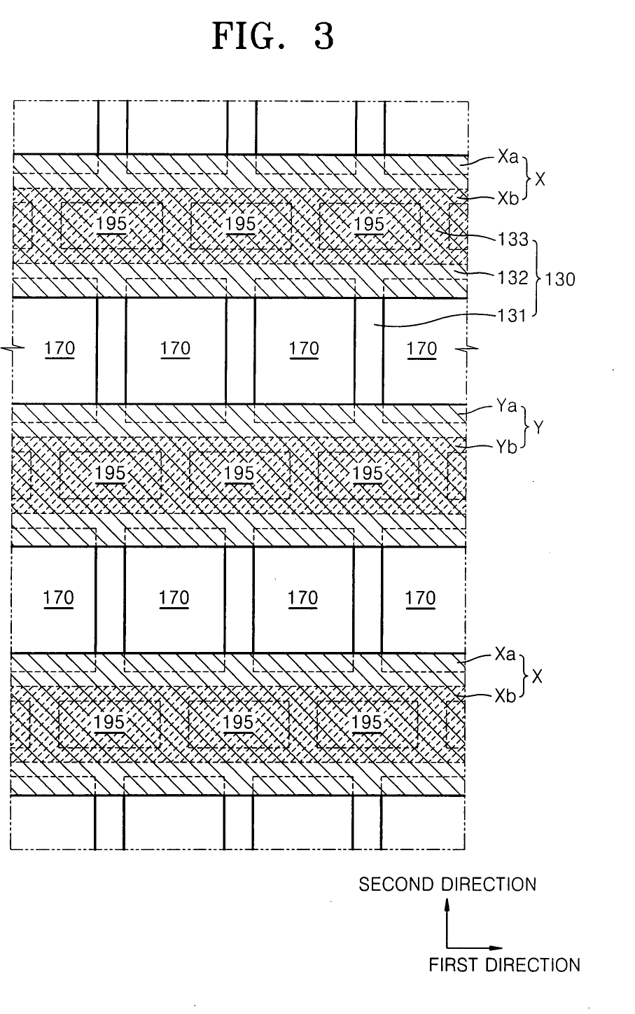

FIGS. 1 through 3 illustrate a plasma display panel (PDP) 100 according to an embodiment. FIG. 1 is a partially exploded, perspective view of the PDP 100. FIG. 2 is a cross-sectional view of the plasma display panel 100 illustrated in FIG. 1, taken along the line II-II. FIG. 3 is an arrangement plan illustrating the location of sustain electrodes X and Y, a barrier rib structure 130, and discharge cells 170 illustrated in FIG. 1.

Referring to FIG. 1, the PDP 100 includes a front panel 150 and a rear panel 160 that are combined to face each other. The front panel 150 includes a front substrate 111, the sustain electrodes X and Y, a protective layer 116, and a front dielectric layer 115. The rear panel 160 includes a rear substrate 121, a rear dielectric layer 125, address electrodes 122, the barrier rib structure 130, and phosphor layers 126. A discharge gas (not shown) is filled in a space between the front and rear panels 150 and 160.

The front substrate 111 generally includes a material having good transmittance of visible light, such as, for example, glass. The front substrate 111 may also be colored to improve room bright contrast.

The rear substrate 121 is arranged to face the front substrate 111 while being spaced a predetermined interval from the front substrate 111. The rear substrate 121 is preferably formed of a material containing glass. The rear substrate may also be colored to improve room bright contrast.

Referring to FIGS. 1 and 3, the barrier rib structure 130 that defines a plurality of discharge cells 170 where a discharge occurs is located between the front and rear substrates 111 and 121. In the shown embodiment, the discharge cells 170 are arranged in the pattern of matrix, and more particularly, they are comprised of a plurality of rows and a plurality of columns. However, the present embodiments are limited thereto and can be arranged in any of various patterns.

The barrier rib structure 130 prevents optical/electrical cross-talk between the adjacent discharge cells 170. The barrier rib structure 130 includes first partitions 131 that define the discharge cells 170 arranged in a row direction (first direction), and second partitions 132 connecting the first partitions 131. Thus, each of the discharge cells 170 has a closed structure defined by the two facing first partitions 131 and the two facing second partitions 132.

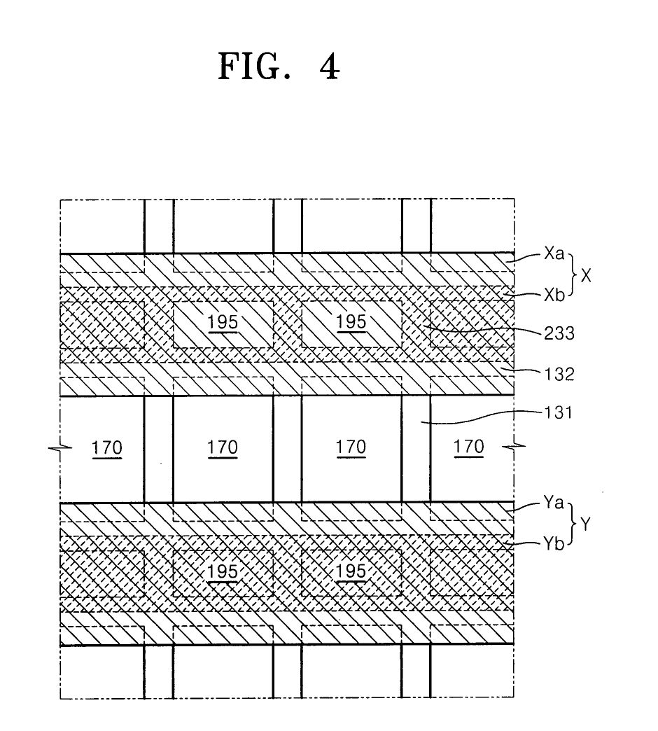

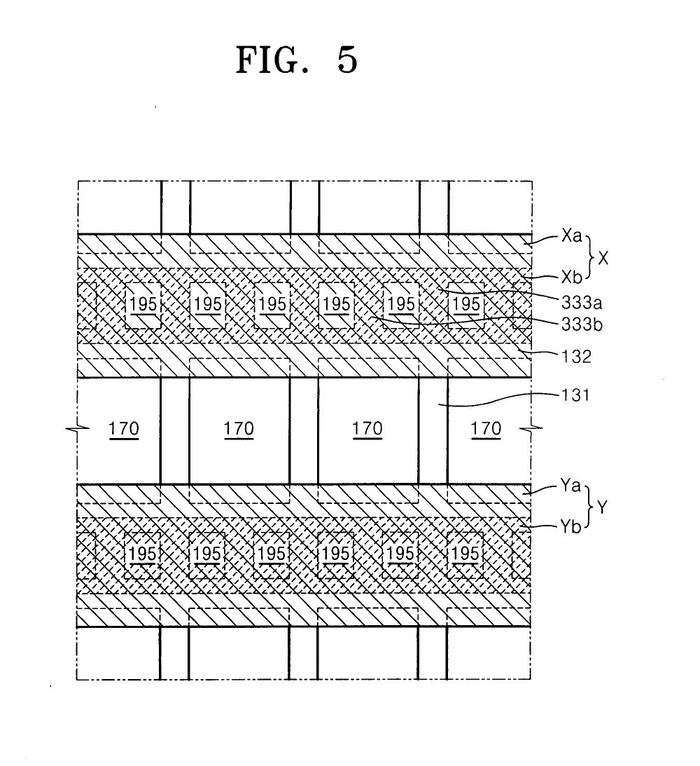

The discharge cells 170 arranged in the row direction (first direction) are separated from one another at predetermined intervals. The barrier rib structure 130 further includes third partitions 133 arranged in spaces between the separated discharge cells 170. Also, the third partitions 133 are arranged to connect substantial middle parts of the adjacent second partitions 132. However, the location of the third partitions 133 is not limited thereto. Referring to FIG. 4, third partitions 233 are aligned with respect to first partitions 131. Also, as illustrated in FIG. 5, parts 333a of third partitions may be aligned with respect to first partitions 131 and the other parts 333b may be aligned to connect the middle parts of the adjacent second partitions 132.

Referring to FIGS. 1 and 2, the height H1 of the first partitions 131 is lower than the height H3 of the third partitions 133. The height H1 denotes the averaged height of the uppermost surfaces 131a of the first partitions 131. Similarly, the height H3 denotes the averaged height of the uppermost surfaces 133a of the third partitions 133.

A groove 190 is formed between the front panel 150 and the uppermost surface 131a of the first partition 131 in each of the discharge cells 170 arranged in the row direction (first direction), thereby allowing gas to be ventilated via the groove 190. Thus, the grooves 190 allow smooth ventilation.

In particular, middle portions 131b of the first partitions 131 are sunken. Since the sunken portions 131b are shorter than both the edge parts of the first partitions 131, the sizes of the grooves 190 are increased, thus improving the ventilating capability.

Referring to FIGS. 1 and 3, the sustain electrodes (X,Y) are arranged in parallel on the front substrate 111 facing the rear substrate 121, at regular intervals. The sustain electrodes (X,Y) generate a discharge in the discharge cells 170. A pair of an X electrode X and a Y electrode Y are arranged in each of the discharge cells 170. Thus, each sustain electrode acts as an X electrode or a Y electrode. The sustain electrodes are comprised of X electrodes X and Y electrodes Y that are alternately, repeatedly arranged.

The sustain electrodes (X,Y) extend in the row direction (first direction). Each pair of the sustain electrodes X and Y include bus electrodes Xb and Yb, and transparent electrodes Xa and Ya that are respectively, electrically connected to the bus electrodes Xb and Yb. The widths of the transparent electrodes Xa and Ya are wider than the bus electrodes Xb an Yb, and the bus electrodes Xb and Yb are respectively aligned on the transparent electrodes Xa and Ya.

The bus electrodes Xb and Yb are arranged to overlap with a part of non-discharge regions 195 between the rows of the discharge cells 170 and a part of the third partitions 133. The bus electrodes Xb and Yb are generally formed of metal having good conductivity. Also, the bus electrodes Xb and Yb are multilayered structures, at least one of which has a dark color, which can improve bright room contrast.

Also, the transparent electrodes Xa and Ya extend from the non-discharge regions 195 between the rows of the discharge cells 170 to the inside of the discharge cells 170. Accordingly, the transparent electrodes Xa and Ya correspond to all of the discharge cells 170 of adjacent rows, and thus act in the corresponding discharge cells 170.

The front dielectric layer 115 is formed on the front substrate 111 to bury the sustain electrodes (X,Y). The front dielectric layer 115 prevents the adjacent X and Y electrodes X and Y from being electrically connected, and charged particles/electrons from directly colliding against the X and Y electrodes X and Y not to damage the X and Y electrodes X and Y. Also, the front dielectric layer 115 induces electric charges.

Also, the protective layer 116 that is generally formed of MgO, is disposed on the front dielectric layer 115. The protective layer 116 prevents positive ions and electrons from colliding against the front dielectric layer 115 during a discharge not to damage the front dielectric layer 115, has good transmittivity of light, and discharges a lot of secondary electrons during a discharge. The protective layer 116 can be formed to a thin film by using sputtering, electron beam deposition, and the like.

The address electrodes 122 are arranged on the rear substrate 121 facing the front substrate 111 to intersect the X and Y electrodes X and Y thereon. The address electrodes 122 are used to generate an address discharge to facilitate a sustain discharge between the X and Y electrodes X and Y, and to lower voltage for generating a sustain discharge. An address discharge occurs among the Y electrodes Y and the address electrodes 122.

The rear dielectric layer 125 is formed on the rear substrate 121 to bury the address electrodes 122 thereon. The rear dielectric layer 125 is formed of a dielectric. Also, the rear dielectric layer 125 prevents positive ions or electrons from colliding against the address electrodes 122 during a discharge so as not to damage the address electrodes 122.

The phosphor layers 126, each emitting red, green, or blue light, are formed on the rear dielectric layer 125 corresponding to the discharge cells 170, and along the sidewalls of the barrier rib structure 130. The phosphor layers 126 contain a component that receives ultraviolet light and generates visible light. The red light emitting phosphor layers 126 formed on the red discharge cells 170 contain a phosphor such as Y(V, P)O₄:Eu. The green light emitting phosphor layers 126 formed on the green discharge cells 170 contain a phosphor such as Zn₂SiO₄:Mn. The blue light emitting phosphor layers 126 formed on the blue discharge cells 170 contain a phosphor such as BAM:Eu.

Also, as described above, the discharge cells 170 are filled with a discharge gas that can be a mixture of Ne, Xe, and the like. While the discharge cells 170 are filled with the discharge gas, the front and rear substrates 111 and 121 are sealed via a sealing unit, such as frit glass, which is formed along the edges of the front and rear substrates 111 and 121.

The operation of the PDP 100 according to an embodiment will now be described. When address voltage is applied among the address electrodes 122 and the Y electrodes Y, an address discharge is generated to select some of the discharge cells, in which a sustain discharge will occur. Then, sustain voltage is applied between the X and Y electrodes X and Y of the selected discharge cells 170 so as to generate a sustain discharge.

Ultraviolet light is emitted when the energy level of the discharge gas excited during the sustain discharge is lowered. Then, the phosphor layers 126 applied onto the discharge cells 170 are excited by the ultraviolet light, and the energy levels of the excited phosphor layers 126 are lowered to emit visible light. The emitted visible light forms an image.

The present embodiments provide a PDP with improved ventilating capability of exhausting impure gas remaining in discharge cells.

While these embodiments have been particularly shown and described with reference to exemplary embodiments thereof, it will be understood by those skilled in the art that various changes in form and details may be made therein without departing from the spirit and scope of the embodiments as defined by the appended claims.

What is claimed is:

1. A plasma display panel comprising:
a front substrate;
a rear substrate located to face the front substrate, the rear substrate defining together with the front substrate a plurality of discharge cells which are arranged in a row direction and a column direction; and
a barrier rib structure including first partitions formed between discharge cells arranged in the row direction, second partitions connecting the first partitions, and third partitions arranged between rows of the discharge cells,
wherein the height of the first partitions is lower than the height of the third partitions.

2. The plasma display panel of claim 1, wherein middle parts of the first partitions are sunken.

3. The plasma display panel of claim 1, wherein the third partitions are arranged to connect substantial middle parts of the adjacent second partitions.

4. The plasma display panel of claim 1, wherein the third partitions are arranged to substantially correspond to the first partitions.

5. The plasma display panel of claim 1, wherein the third partitions are arranged to substantially correspond to middle parts of the second partitions, and the first partitions.

6. The plasma display panel of claim 1, further comprising sustain electrodes extending along the discharge cells arranged in the row direction.

7. The plasma display panel of claim 6, wherein at least a part of each of the sustain electrodes is arranged to correspond to a region between rows of the discharge cells.

8. The plasma display panel of claim 7, wherein each of the sustain electrodes operates in all of the discharge cells of adjacent rows.

9. The plasma display panel of claim 8, wherein each of the sustain electrodes comprises:
a bus electrode arranged to correspond to a region between rows of the discharge cells; and
a transparent electrode which is electrically connected to the bus electrode and extends in the row direction of the discharge cells.

10. The plasma display panel of claim 6, wherein the sustain electrodes are arranged between the barrier rib structure and the front substrate.

11. The plasma display panel of claim 6, further comprising:
address electrodes extending to intersect the sustain electrodes;
a front dielectric layer and a rear dielectric layer formed to respectively bury the sustain electrodes and the address electrodes;
phosphor layers arranged in the discharge cells; and
a discharge gas filled in the discharge cells.

12. The plasma display panel of claim 1, further comprising non-discharge regions which are arranged between the rows of the discharge cells and are defined by the second partitions and the third partitions.

13. The plasma display panel of claim 12, further comprising phosphor layers arranged in the discharge cells and in the non-discharge regions.
